(19) United States
(12) Patent Application Publication
(10) Pub. No.: US 2011/0182729 A1
(43) Pub. Date: Jul. 28, 2011

(54) LEAF SEALS

(76) Inventors: Siva Sivakumaran, Lincoln (GB); Geir Leivseth, Lutterworth (GB)

(21) Appl. No.: 12/940,497

(22) Filed: Nov. 5, 2010

(30) Foreign Application Priority Data
Nov. 11, 2009 (GB) 0919708.8

(51) Int. Cl. F04D 29/10; F16J 15/447

(52) U.S. Cl. 415/231; 277/412

(57) ABSTRACT

A leaf seal 10 for location between a higher-pressure region and a lower pressure region of a rotary machine is configured so that radial movement of the free ends of the leaves 20 during operation of the rotary machine affects the aerodynamic forces acting upon the leaves 20. In particular, the housing 28 for the leaves 10 and the leaves themselves are part-conically formed such that when the free ends of the leaves are moved from their resting position, for example during shaft whirling, the gaps 34 and 36 between the upstream edge 21 of the leaf and the inner surface of the adjacent housing side-cheek 30, and between the downstream edge 22 of the leaf and the inner surface of the adjacent housing side-cheek 32, are altered. This alteration of the gaps can be used to provide improved control over the aerodynamic forces acting upon the leaves 20.

This application claims priority under 35 U.S.C. §119 to UK application number No. 0919708.8, filed 11 Nov. 2009, the entirety of which is incorporated by reference herein.

### BACKGROUND

1. Field of Endeavor

The present disclosure relates to the sealing of gaps between relatively rotating machine components to control fluid leakage therethrough, and in particular, to an improved form of leaf seal.

2. Brief Description of the Related Art

It is common practice in rotating machinery, such as gas and steam turbines, to prevent excessive fluid leakage between relatively rotating components by providing them with various types of sealing arrangements. For example, the relatively rotating components may be a shaft rotating within static structure, such as a bearing housing or a diaphragm that divides areas at different pressures within a turbine. Other examples of relatively rotating components include a stage of compressor rotor blades that rotates within a surrounding compressor casing or of turbine rotor blades that rotates within a turbine casing. Common types of seal used in such situations are labyrinth seals, fin seals and brush seals.

In recent years, so-called “leaf seals” have been the subject of research and development to replace other types of seals in certain situations, particularly where the relatively rotating components are a rotating shaft and a diaphragm penetrated by the rotating shaft. FIG. 1 is a part-sectional perspective sketch of a typical leaf seal 10. The leaf seal 10 is installed around a shaft 12 between a higher-pressure region 14 and a lower-pressure region 16 and generally includes an annular array 18 of thin, resiliently flexible metal leaves 20. The individual leaves 20 are of a generally rectangular shape and are oriented so that they each present their side edges 21, 22 to the fluid leakage flow 24 through the annulus 18 of the leaf seal 10. In particular, each leaf 20 has an upstream edge 21 and a downstream edge 22 relative to the fluid leakage flow 24 through the annulus of the leaf seal 10. The upstream edges 21 and the downstream edges 22 of the leaves 20 occupy parallel radially extending planes that are spaced apart along the axis of rotation of the shaft. To protect the upstream and downstream edges 21, 22 of the leaves 20 and to restrict fluid leakage flow 24 through the leaf seal 10, the upstream and downstream edges 21, 22 of the leaves 20 are covered by an upstream side-cheek 30 and a downstream side-cheek 32, respectively, of a housing 28.

In FIG. 1, the leaves 20 are cantilevered, with their radially outer ends held encastré in the outer part of housing 28. Alternatively, but with greater manufacturing costs, the outer ends of the leaves can be held so that they are able to pivot a limited amount about their outer ends; this is more advantageous if semi-rigid leaves are used. To allow the free ends of the leaves to move relative to each other, the outer ends of the leaves are spaced apart from one another in pockets 34 of a spacer component 40 of the housing 28 and with their lengths extending from the housing 28 towards the shaft 12 such that their free ends 35 are adjacent to, or touching, the shaft surface. The leaves 20 extend from the housing 28 in a direction that is offset from the radial direction of the shaft 12 in the direction of rotation of the shaft, the direction of rotation being shown by the arrow 38. In this manner the inherent resilience or pivoting ability of the leaves 20 can be used to allow their free ends to bend or move away from the shaft 12 when small radial excursions of the shaft cause the shaft surface to come into interfering contact with the free ends of the leaves. Such radial excursions of the shaft are called “shaft-whirling” and may be caused by rotor imbalance or large fluctuations in torque loading.

The upstream and downstream side-cheeks 30, 32 of the housing 28 are annular, being of uniform thickness and radially oriented with respect to shaft 12. The upstream side-cheek 30 has an inner face that occupies a radial plane and is adjacent and parallel to the upstream edges 21 of the leaves 20. The downstream side-cheek 32 has an inner face that occupies a radial plane and is adjacent and parallel to the downstream edges 22 of the leaves 20. The upstream edges 21 are separated from the inner face of the upstream side-cheek 30 by a gap, as are the downstream edges 22 and the inner face of the downstream side-cheek 32. In operation, the leaves 20 flex or move in a direction parallel to the inner face of the upstream side-cheek 30 and inner face of the downstream side-cheek 32. Therefore, the gap between the upstream edges 21 and the inner face of the upstream side-cheek 30 and the gap between the downstream edges 22 and the inner face of the downstream side-cheek 32 remains substantially constant during operation.

As the rotor surface rotates past the leaves of a leaf seal, they are subject to a number of forces.

Firstly, consider mechanical forces. If the leaves of a leaf seal are mechanically bent by aerodynamic forces or by contact with the rotor surface, they will resist that bending due to their inherent resilience and tend to be restored to their position of least bending stress.

Secondly, each leaf of a leaf seal is affected by aerodynamic forces that result in either a “blow-down” effect or a “blow-up” effect. Blow-down or blow-up is the tendency of the leaves to be blown against or away from the surface of the rotating component by aerodynamic forces generated by the rotation of the rotating component and the pressure differential across the seal. If the aerodynamic forces produce a blow-up effect, it assists in providing an “air-riding” mode of seal operation, whereby a thin boundary layer of air is maintained between the free ends of the leaves and the moving rotor surface so that contact or excessive contact between the leaves and the rotor surface is minimized. However, an excessive blow-up effect will be deleterious to seal efficiency because it will increase leakage through the gap between the seal and the rotor surface. On the other hand, if the aerodynamic forces produce an excessive blow-down effect, it may disrupt the “air-riding” mode of seal operation. Nevertheless, under some circumstances, an increased blow-down effect may be beneficial in preserving seal efficiency.

Thirdly, there is a shear force set up in the boundary layer between the surface of the rotating component and the free ends of the leaves of the leaf seal. The shear force will exert drag on the free end of each leaf, acting tangentially to the rotor in the direction of rotation of the rotor. The magnitude of the drag force is dependent upon the relative speed between the free ends of the leaves and the surface of the rotating component and upon the fluid pressure and viscosity at the surface of the rotor. If the components of the tangential drag force are resolved at right angles, one component will tend to bend or move the leaves so that their free ends lift away from the rotor surface, thereby assisting the above-mentioned air-riding effect, while the other component will tend to put the leaves under tension, so tending to straighten them. Assuming that the leaves are inclined in the direction of rotation of the rotor, as in FIG. 1, the lifting component of the drag force will be appreciably greater than the tension component, but it has been found that the lifting component can be overcome by the mechanical and aerodynamic blow-down forces if the operating conditions of the leaf seal move very far outside of its design envelope, e.g., due to shaft whirl. Hence, if the sum of the mechanical restoring forces and aerodynamic blow-down forces becomes greater than the sum of the lifting and aerodynamic blow-up forces, the air-riding effect may be overcome and the free ends of the leaves may contact the rotor surface. An excessive amount of such contact is undesirable as it can result in premature wear and frictional over-heating of the leaves and/or the contacting surface of the rotating component. Conversely, if the sum of the lifting and aerodynamic blow-up forces becomes greater than the sum of the mechanical restoring forces and aerodynamic blow-down forces, the gap between the free ends of the leaves and the rotor surface may become excessive, thereby impairing sealing efficiency.

In light of the above, there is a need for a leaf seal for a rotating machine that can provide some additional control over the aerodynamic forces acting upon the leaves during operation of the rotary machine and in particular during shaft whirling. Advantageously, the leaf seal should provide improved protection against excessive blow-down and/or blow-up forces during operation of the rotary machine.

### SUMMARY

Consequently, one of numerous aspects of the present invention includes a leaf seal for locating between a higher pressure region and a lower pressure region of a rotary machine, the leaf seal comprising:

an annular housing having an upstream side-side-cheek and a downstream side-cheek; and

an annular array of resilient leaves arranged between the upstream side-cheek and the downstream side-cheek for forming a seal between a static structure and a rotating component of the machine, each leaf having

a radially outer end held within the housing,

a radially inner free end,

an upstream edge adjacent to an inner surface of the upstream side-cheek, and

a downstream edge adjacent to an inner surface of the downstream side-cheek;

the upstream edges of the leaves and the adjacent side-cheek defining an upstream gap therebetween and the downstream edges of the leaves and the adjacent side-cheek defining a downstream gap therebetween; wherein

at least one of the inner surface of the upstream side-cheek and the inner surface of the downstream side-cheek is frustoconical and angled relative to the radial direction so that an apex of the equivalent cone is further towards the higher pressure region of the rotary machine than the base of the cone;

the leaf edges adjacent the or each side-cheek inner surface define a respective similarly oriented frustocone; and

in the case where only one of the inner surfaces of the side-cheeks is frustoconical, the inner surface of the other side-cheek and the leaf-edges adjacent thereto occupy respective radial planes.

In the foregoing, the term “equivalent cone” describes the frustoconical surface as notionally extended to form a complete cone and the term “radial” defines radial directions relative to the center of rotation of the rotor.

Because the frustoconical inner surface of the upstream side-cheek and/or the downstream side-cheek, and the adjacent leaf edges, are angled relative to the radial direction in the way specified above, the upstream gap and/or downstream gap vary in the preferred manner as the free end of the leaf moves outwards or inwards. That is, when the free end of a leaf moves in a radial sense, the upstream gap and/or the downstream gap changes, whereby when the seal is in use the aerodynamic forces on the leaf are altered.

In the prior art leaf seal of FIG. 1, the upstream gap is substantially the same as the downstream gap, and during inward or outward movement of the rotor, both gaps tend to remain substantially constant. Consequently, they do not substantially affect the aerodynamic forces acting upon the leaf. In contrast, another aspect of the present invention includes a construction in which radial movements of the rotor causes the upstream gap and/or the downstream gap to vary, which in turn varies the aerodynamic forces acting upon the leaves. This is particularly advantageous as it allows some automatic control of the blow-up and blow-down effects to be designed into the leaf seal. An aim of such a design is to maintain the air-riding effect while avoiding an excessive gap between the free ends of the leaves and the rotor surface.

In a preferred embodiment, the leaves and the side-cheeks are configured such that when the free end of a leaf moves in the radially outwards direction, the upstream gap decreases and the downstream gap increases. Generally, decreasing the size of the upstream gap relative to the size of the downstream gap will shift the aerodynamic forces towards blow-up, thereby assisting restoration or maintenance of the air-riding effect.

The same preferred configuration of the leaves and the side-cheeks will cause the seal to operate such that, when the free end of a leaf is moved in the radially inwards direction, the upstream gap increases and the downstream gap decreases. Generally, increasing the size of the upstream gap relative to the size of the downstream gap will shift the aerodynamic forces acting on the leaf towards blow-down, thereby helping to minimize leakage through the seal.

In a preferred configuration of the side-cheeks and the leaves of the leaf seal, both the inner surface of the upstream side-cheek and the inner surface of the downstream side-cheek are frusto-conical; consequently, the upstream and downstream edges of the leaves also define respective frustocones. In a most preferred configuration, the inner side-cheek surfaces and the adjacent edges of the leaves are frustoconical to the same extent as each other, such that in their as-assembled or at rest condition, the edges of the leaves lie parallel to their adjacent side-cheek surfaces. However, it may be possible to at least partially obtain the desired modification of blow-up and blow-down effects by configuring the side-cheeks so that only one of the inner surface of the upstream side-cheek and the inner surface of the downstream side-cheek is substantially frusto-conical, with the edges of the leaves adjacent said one inner surface also being substantially frusto-conical in the same sense, though not necessarily to the same extent.

When the leaves of the above-described leaf seal are in their as-assembled or resting position, the upstream edges of the leaves are advantageously parallel to the inner surface of the upstream side-cheek, and/or the downstream edges of the leaves are parallel to the inner surface of the downstream side-cheek. In this way, if the inner surface of a side-cheek is frusto-conical and the adjacent edge of a leaf is parallel to that surface when the leaf is in its resting position, the size of the gap between that edge and the inner surface of the side-cheek will alter in a regular and predictable manner when the leaf is moved away from its resting position.

Preferably, the leaves of the above leaf seal are substantially planar when there are no external forces acting upon the leaves and they are in their resting position. In this case, each leaf will be substantially parallelogram-shaped with its upstream edge parallel to its downstream edge; and its radially outer end may also be parallel to its free end. However, it is by no means necessary for the outer ends of the leaves to be formed parallel with their free ends. For example, the shape of the outer ends may be dictated by the way they are held in the housing. Planar leaves are preferred as they are easier to form and mount. However, it is to be understood that leaf seals according to the present disclosure may also be formed with leaves that are substantially non-planar when in their resting position. For example, the leaves may be curved in a radial direction.

It is also preferred that each leaf extends from the housing in a direction that is offset from the radial direction of the rotating component in a direction of the rotation of the rotating component, as in leaf seals according to the prior art.

Such leaf seals may be used with or include part of any suitable rotary machine. For example, an axial flow compressor or a gas or steam turbine may include a leaf seal as described herein.

Further aspects and advantages of leaf seals as summarized above will be apparent to the person skilled in the art from the preferred embodiments illustrated in FIGS. 2 to 5 and described below.

### BRIEF DESCRIPTION OF THE DRAWINGS

Some embodiments of the above-summarized concepts will now be described, by way of example only, with reference to the accompanying drawings, in which:

FIG. 1 is a sectional view of a portion of a leaf seal according to the prior art;

FIG. 2 is a cross-sectional view of a portion of a preferred embodiment of a leaf seal in its as-assembled or resting position;

FIGS. 3 and 4 are cross-sectional views of the leaf seal of FIG. 2 when the leaf seal is in operation and experiencing shaft whirling; and

FIG. 5 is a view like FIG. 2, but illustrating a further embodiment of a leaf seal in its resting position.

### DETAILED DESCRIPTION OF EXEMPLARY EMBODIMENTS

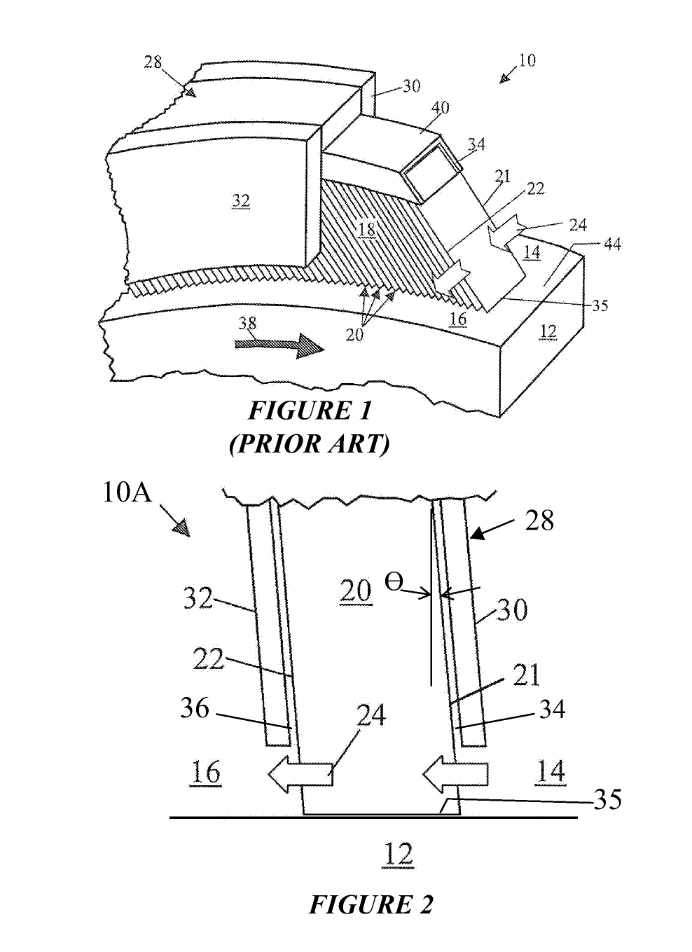

FIG. 2 is a cross-section through a leaf seal 10A according to a preferred design of leaf seal. Other than those features described below, the leaf seal 10A of FIG. 2 is substantially as illustrated in FIG. 1 and previously described. For convenience of comparison, the features of the leaf seal 10A of FIG. 2 are mostly indicated by the same reference numerals as those of the leaf seal 10 in FIG. 1. FIG. 2 shows the leaf seal 10A with a representative leaf 20 in its resting position.

The leaf seal 10A is installed around a shaft 12 between a higher-pressure region 14 and a lower-pressure region 16. There is a fluid leakage flow 24 through an annulus of the leaf seal 10 from the upstream (relatively high pressure) side 14 of the seal to the downstream (relatively low pressure) side 16.

The leaf seal 10A includes a housing having an upstream side-cheek 30 and a downstream side-cheek 32. The upstream side-cheek 30 and the downstream side-cheek 32 are frustocones, i.e., they are substantially frusto-conical in shape, with their frusto-conical inner and outer surfaces angled relative to the radial direction at an angle θ (theta) so that the notional apex of the cone is further towards the higher pressure region 14 than the cone's base.

Though non-planar configurations are possible, in the present embodiment leaf 20 is planar and parallelogram-shaped, with its upstream edge 21 parallel to its downstream edge 22 and its radially outer end (not shown) parallel to its radially inner free end 35. It should be noted here, however, that the leaf's outer end is mechanically retained within the housing, so depending on the method of fixing and the manufacturing process, it is not actually necessary for the leaf's outer end to be parallel with its inner end.

Note also that the leaf's upstream and downstream edges 21 and 22 have the same cone angle θ as the side-cheeks 30 and 32 of the housing. Thus, the leaf's upstream edge 21 is adjacent and parallel to an inner surface of the upstream side-cheek 30 and its downstream edge 22 is adjacent and parallel to an inner surface of the downstream side-cheek 32. Alternatively, if necessary to fine-tune the design, the cone angles of the leaf edges and the adjacent side-cheek inner surfaces could differ by up to one or two—or perhaps several—degrees, i.e., they would be frusto-conical in the same sense, but not exactly to the same degree.

In the particular case of FIG. 2, the upstream gap 34 between the leaf's upstream edge 21 and the inner surface of the upstream side-cheek 30 is the same as the downstream gap 36 between the leaf's downstream edge 22 and the inner surface of the downstream side-cheek 32. Nevertheless, it should be understood that the relative dimensions of the upstream and downstream gaps 34, 36 may be varied by the designer in order to fine-tune the design.

Although only a single leaf 20 can be shown in FIG. 2, it is to be understood that each leaf of the leaf seal is substantially identical and each of the leaves is arranged in the same manner relative to the upstream side-cheek 30 and the downstream side-cheek 32. The leaves 20 extend from the housing of the leaf seal 10A in a direction that is offset from the radial direction of the shaft 12 in the direction of rotation of the shaft in the same manner as in the prior art leaf seal illustrated in FIG. 1.

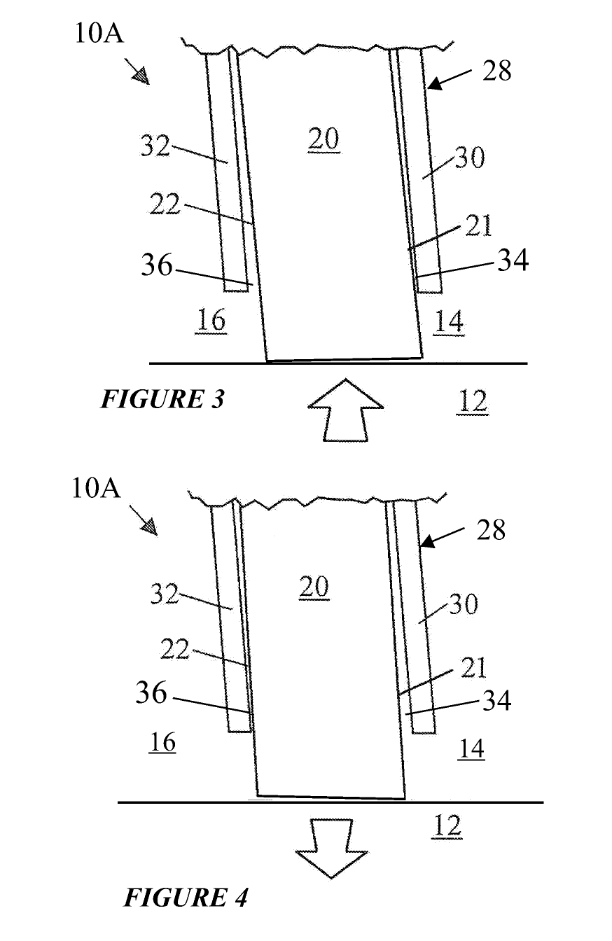

As illustrated in FIG. 3, when the shaft 12 is displaced radially outwards (large arrow) during shaft whirling, the free ends of the leaves will move outwards, thereby reducing the cone angle so that the upstream gap 34 decreases and the downstream gap 36 increases. Narrowing of the upstream gap 34 increases the aerodynamic blow-up forces, while at the same time widening of the downstream gap 36 reduces the aerodynamic blow-down forces. Hence, the overall aerodynamic forces are shifted towards blow-up, thereby helping to maintain or restore an overall air-riding effect between the leaves 20 and the shaft 12.

FIG. 4 illustrates what happens when the shaft is displaced radially away (large arrow) from the leaves 20 during shaft whirling. As the rotor surface recedes from the leaves, the free ends of the leaves will move inwards, thereby increasing the cone angle so that the upstream gap 34 increases and the downstream gap 36 decreases. Widening of the upstream gap 34 reduces the aerodynamic blow-up forces, while at the same time narrowing of the downstream gap 36 increases the aerodynamic blow-down forces. Hence, the overall aerodynamic forces are shifted towards blow-down, thereby helping to maintain the integrity of the seal 10A by maintaining a relatively small gap between the leaves 20 and the shaft 12.

It has been shown above how variations in the upstream and downstream gaps 34, 36 as the leaves 20 are moved during shaft whirling affects the aerodynamic forces acting upon the leaves 20. It will be understood by the skilled person that this effect can be tuned for a particular design case by varying the upstream and downstream gaps, and the cone angles of the upstream side-cheek 32, the downstream side-cheek 34 and the upstream and downstream edges 21, 22 of the leaves 20 in order to counter the changes in mechanical force, shear force, and aerodynamic force acting upon the leaves during operation of a rotating machine and thereby maintain both the air riding effect and the efficiency of the seal 10A.

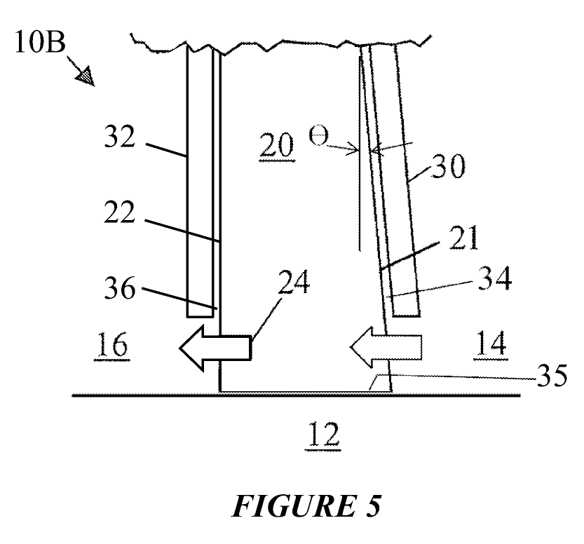

FIG. 5 shows how it may be possible to at least partially obtain the desired modification of blow-up and blow-down effects by configuring the side-cheeks of a leaf seal 10B so that only one of the side-cheeks is frusto-conical. In the particular case shown, the upstream side-cheek 30 is frusto-conical but the down-stream side-cheek 32 is oriented entirely radially, at right angles to the circumference of the rotor 12. In this embodiment, the upstream edges 21 of the leaves have the same cone angle θ (theta) as the adjacent inner surface of the up-stream side-cheek 30. Alternatively, if necessary to fine-tune the design, the cone angles of the leaf edges 21 and the adjacent side-cheek inner surface could differ by up to one or two—or perhaps several—degrees, i.e., they would be frusto-conical in the same sense, but not exactly to the same degree.

In FIG. 5, if the shaft 12 is displaced radially outwards during shaft whirling, the free ends 35 of the leaves will move outwards, thereby reducing the cone angle θ so that the upstream gap 34 decreases, so increasing the aerodynamic blow-up forces. However, the downstream gap 36 will remain substantially the same, so unlike the embodiment of FIG. 2, the aerodynamic blow-down forces will not be substantially reduced. Hence, the overall aerodynamic forces will not be shifted towards blow-up as much as for FIG. 2.

If, on the other hand, the rotor surface recedes from the leaves, the free ends of the leaves will move inwards, thereby increasing the cone angle θ so that the upstream gap 34 increases while the downstream gap 36 remains substantially the same. Widening of the upstream gap 34 reduces the aerodynamic blow-up forces, but the aerodynamic blow-down forces will not be substantially increased. Hence, the overall aerodynamic forces for leaf seal 10B will not be shifted towards blow-down as much as for leaf seal 10A in FIG. 2.

The skilled person will readily appreciate from a perusal of FIG. 5 that an alternative arrangement can be realized by making the down-stream side-cheek 32 frusto-conical and orienting the up-stream side-cheek 32 radially. The above comments concerning blow-up and blow-down forces can be applied mutatis mutandis to this alternative arrangement.

The above description is purely exemplary, and modifications can be made within the scope of the present invention, which should not be limited by the above-described exemplary embodiments. Each feature disclosed in the specification, including the claims and drawings, may be replaced by alternative features serving the same, equivalent or similar purposes, unless expressly stated otherwise.

Unless the context clearly requires otherwise, throughout the description, the words “comprise”, “comprising”, and the like, are to be construed in an inclusive as opposed to an exclusive or exhaustive sense; that is to say, in the sense of “including, but not limited to”.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A leaf seal for locating between a higher pressure region and a lower pressure region of a rotary machine, the leaf seal comprising:
an annular housing defining a radial direction and having an upstream side-cheek and a downstream side-cheek, each cheek having an inner surface; and
an annular array of resilient leaves arranged between the upstream side-cheek and the downstream side-cheek for forming a seal between a static structure and a rotating component of the machine, each leaf having
a radially outer end held within the housing,
a radially inner free end,
an upstream edge adjacent to the inner surface of the upstream side-cheek, and
a downstream edge adjacent to the inner surface of the downstream side-cheek;
wherein upstream edges of the leaves and the adjacent side-cheek define an upstream gap therebetween and downstream edges of the leaves and the adjacent side-cheek define a downstream gap therebetween;
wherein at least one of the inner surface of the upstream side-cheek and the inner surface of the downstream side-cheek is frustoconical and angled relative to the radial direction so that an apex of the cone is further towards the higher pressure region of the rotary machine than the base of the cone;
wherein leaf edges adjacent each side-cheek inner surface define a respective similarly-oriented frustocone.

2. A leaf seal according to claim 1, wherein the leaves and the side-cheeks are configured such that when the free end of a leaf moves in the radially outwards direction, the upstream gap decreases, the downstream gap increases, or both, thereby respectively increasing the aerodynamic blow-up forces, decreasing the aerodynamic blow-down forces, or both forces, acting on the leaves.

3. A leaf seal according to claim 1, wherein the leaves and the side-cheeks are configured such that when the free end of a leaf moves in the radially inwards direction, the upstream gap increases, the downstream gap decreases, or both, thereby respectively decreasing the aerodynamic blow-up forces, increasing the aerodynamic blow-down forces, or both forces, acting on the leaves.

4. A leaf seal according to claim 1, wherein the inner surface of the upstream side-cheek and the inner surface of the downstream side-cheek are both frusto-conical.

5. A leaf seal according to claim 1, wherein only one of the inner surface of the upstream side-cheek and the inner surface of the downstream side-cheek is frusto-conical.

6. A leaf seal according to claim 1, wherein the edges of the leaves lie parallel to their adjacent side-cheek surfaces when in an at rest condition.

7. A leaf seal according to claim 1, wherein each side-cheek has an outer surface extending parallel to its inner surface.

8. A leaf seal according to claim 1, wherein only one of the inner surfaces of the side-cheeks is frustoconical, and the inner surface of the other side-cheek and the leaf-edges adjacent thereto occupy respective radial planes relative to the rotor.

9. An axial flow compressor or turbine including a leaf seal according to claim 1.
